(19) United States
(12) Patent Application Publication
(10) Pub. No.: US 2024/0377788 A1
(43) Pub. Date: Nov. 14, 2024

(54) MECHANICAL HOROLOGICAL MOVEMENT COMPRISING A WHEEL SET CARRYING A DISPLAY MEMBER AND PROVIDED WITH A BRAKING DEVICE

(71) Applicant: ETA SA Manufacture Horlogère Suisse, Grenchen (CH)

(72) Inventors: Baptist WYSSBROD, Nidau (CH); David PHILIPPON, Saint-Imier (CH)

(73) Assignee: ETA SA Manufacture Horlogère Suisse, Grenchen (CH)

(21) Appl. No.: 18/656,771

(22) Filed: May 7, 2024

(30) Foreign Application Priority Data
May 10, 2023 (EP) 23172657.1
May 17, 2023 (EP) 23174095.2

(51) Int. Cl. G04B 19/02; G04B 1/16

(52) U.S. Cl. CPC G04B 19/02; G04B 1/16

(57) ABSTRACT

A mechanical horological movement includes a barrel, an escape wheel set associated with a mechanical resonator, a display wheel set configured to carry a display member including a chronograph hand and driven rotatably by the barrel, and a braking spring configured to generate a braking torque on the display wheel set when the display wheel set is subjected to a rotary drive torque to prevent trembling of the display member. The mechanical horological movement further includes an intermediate part, including a washer, located between the braking spring and an arbor of the display wheel set, the intermediate part being mounted to rotate freely on the arbor. The intermediate part and the braking spring are arranged so that the intermediate part remains stationary and non-rotating in normal operation. The braking spring overall exerts a pressing force over the intermediate part in the direction of the arbor to generate the braking torque.

### TECHNICAL FIELD OF THE INVENTION

The present invention relates to a mechanical horological movement comprising a wheel set carrying a display member, in particular a hand, and equipped with an anti-trembling device, also referred to as an anti-vibration device, formed by a braking device acting on the wheel set to prevent the display member from trembling when rotating and also from floating when stationary, where appropriate.

### TECHNOLOGICAL BACKGROUND

Document CH 580301 discloses an anti-trembling device for a horological wheel set, in particular a chronograph wheel set, also referred to hereinafter as a “chrono wheel set”, comprising an arbor fitted with a pinion, which meshes with a clutch wheel, referred to hereinafter as the “driving wheel”, forming a coupling device for a chronograph mechanism. It should be noted that an arbor fitted with pivots to guide the rotation thereof is also referred to as a ‘shaft’ in watchmaking. The anti-trembling device for the seconds hand of the chronograph function is formed by a friction device comprising a wire spring bearing obliquely against said arbor, which has a frustoconical shoulder for this purpose, the wire spring having a bearing point in the angle formed by this shoulder and a circular cylindrical part, the diameter whereof corresponds to the minimum diameter of the shoulder, and exerting, at this point, an oblique force on said arbor, so that the toothing of the pinion presses against the driving wheel and so that a lower annular surface of the arbor, opposite said shoulder and orthogonal to the axis defined by the arbor, presses axially against a bearing in which the chronograph wheel set pivots. The spring is designed to be rectilinear in the absence of stress. This spring is fastened to the frame of the movement on the side of a first end, whereas a part of the side of the second end is under tension and presses against the arbor, as explained above.

For a number of reasons, this anti-trembling device poses a problem concerning control of the moment of frictional force applied to the chronograph wheel set. Moreover, there is no way of adjusting this moment of frictional force. Subsequently, when the chronograph hand (chrono hand) is removed, the spring is subjected to an axial force which can damage this spring.

Document DE 6800934 U describes a solution for improving control of the moment of frictional force applied to a seconds wheel set. According to the teaching of this document, the wire spring or strip spring is fastened, at its first end part, by a riveting technique to a plate which is held suspended by a rivet having a head, with a screw-like slot, arranged on one side of a bar which is opposite the side where the plate is located. The rivet has an intermediate cylindrical part which is inserted into a hole in the bar with a friction fit allowing the rivet and thus the plate and thus the first end part of the spring to undergo a certain rotation with the aid of a tool. The second end part of the friction spring is free and bears radially against a plastic washer that is force-fitted/press-fitted onto the arbor of the seconds wheel set, this washer having a lateral groove in which the second end part of the spring is placed. This system is very difficult to assemble in the horological movement. Firstly, the friction spring must be fastened to the plate, by inserting its first end part into a slot and then pressing material onto the two edges of this slot to perform a first riveting operation. The plate with the friction spring must then be brought to an inner side of the bar after inserting the rivet into the hole in the bar from the other side. The end of the rivet must then be crushed and a second riveting operation must be carried out to fasten the plate to the rivet. It can be seen that, at each stage of assembling the friction spring to the plate and then to the bar, via two successive riveting operations, there is a high risk of damaging the friction spring. Finally, the bar, plate and friction spring assembly is assembled in the horological movement, a priori simultaneously with the insertion of a pivot of the arbor of the seconds wheel set, carrying the grooved washer, into a bearing arranged in the bar concerned. Such an assembly requires that the spring not be stacked on top of the grooved washer, as the spring is rigidly connected to the bar and as the grooved washer, which is designed to receive the free end of the spring under tension, is rigidly connected to the arbor. There is thus a first assembly/disassembly position for the spring and a second working position in which the free end of the spring is brought into the groove in the washer and the spring is tensioned. To move from one position to the other, the watchmaker has to use a tool to act on the rivet head, which causes the spring to lose the tension set when it is removed for maintenance. As a result, each time the seconds wheel set is assembled, the moment of braking force must be readjusted. The assembly method described here is difficult and time-consuming to implement.

Moreover, this anti-trembling device does not provide a perfect solution to the problem of adjusting the moment of force applied to the seconds wheel set to prevent it from trembling, as the friction force is defined in particular by the profile of the lateral groove of the plastic washer and the shape of the end of the spring which is inserted into this groove and presses radially against the washer. Such a friction force is difficult to control and reproduce, as it is highly dependent on the dimensions of the spring and the groove, their respective configurations and their respective surface finishes. Another problem arises from the fact that assembling an intermediate part on the arbor of the seconds wheel set will increase the radial shake of the wheel set, and thus cause greater variation than in the absence of such an intermediate part, particularly if the spring was bearing directly on a conventional arbor with less radial shake. Moreover, in the event of vibrations or impacts to the watch, the second free end of the spring could become detached from the grooved washer, and would no longer guarantee a constant braking torque. Worse still, in the event of a violent impact, the spring fastening plate, which is held in place solely by friction, could move angularly and alter the brake setting.

### SUMMARY OF THE INVENTION

The aim of the present invention is to solve the aforementioned problems of the prior art and also to propose an anti-trembling device for a display wheel set, arranged outside the gear train from the barrel to the escape wheel set, which device is easy to mount and which can, in a preferred alternative embodiment, be mounted in a preliminary step prior to the mounting of the wheel set in question.

To this end, the present invention relates to a mechanical horological movement comprising a barrel, an escape wheel set associated with a mechanical resonator, a display wheel set comprising an arbor and intended to carry a display member, and a braking device associated with the display wheel set and comprising a braking spring and an intermediate part arranged between the braking spring and the arbor of the display wheel set, this display wheel set being able to be driven rotatably by the barrel but not forming part of a gear train from the barrel to the escape wheel set. The braking spring is arranged so as to be able to generate, via the intermediate part against which this braking spring presses, a braking torque on the display wheel set, as soon as the latter is subjected to a rotary drive torque. The intermediate part and the braking spring are arranged so that the intermediate part remains stationary and non-rotating in normal operation. The intermediate part has a lateral surface pressing against a surface of revolution of said arbor, and a bearing surface against which the braking spring exerts an overall pressing force towards the arbor in order to generate a friction force between the lateral surface and the surface of revolution that generates said braking torque.

According to a first advantageous alternative embodiment, the intermediate part and the braking spring are configured in such a way that said pressing force remains constant once the display wheel set has been assembled in the movement and the braking device has been fully assembled and adjusted.

In a preferred general alternative embodiment, the intermediate part exerts exclusively radial pressure on the arbor of the display wheel set.

In a main embodiment, the braking spring is a wire spring or a strip spring whose longitudinal axis lies in a geometric plane parallel to a general plane of the movement.

In one main embodiment, the movement comprises an eccentric whose axis of rotation is perpendicular to said geometric plane and which is arranged to press radially against the braking spring so as to be able to vary, by rotation about its axis of rotation, said radial overall pressing force exerted by the braking spring on the intermediate part.

### BRIEF DESCRIPTION OF THE FIGURES

The invention will be described in greater detail below with reference to the accompanying drawings, which are given by way of non-limiting examples, in which:

FIG. 1 is a partial perspective view of a main embodiment of a mechanical horological movement according to the invention, showing a braking device according to the invention pre-mounted in a preliminary step prior to the assembly of the chronograph wheel set for which the braking device is intended;

FIG. 2 is a plan view of the part of the mechanical horological movement shown in FIG. 1;

FIG. 3 is a sectional view, passing through the central axis of a tube designed to receive part of the arbor of the chronograph wheel set, along the cutting plane III-III in FIG. 2;

FIG. 4 is a bottom view of the mechanical horological movement in the main embodiment once the chronograph wheel set has been fitted;

FIG. 5 is a partial sectional view of the mechanical horological movement along the cutting plane V-V in FIG. 4.

FIG. 6 diagrammatically shows a partial view of a particular alternative embodiment of the main embodiment;

FIGS. 7A and 7B diagrammatically show a partial view of two advantageous alternative embodiments of the main embodiment;

FIG. 8 diagrammatically shows a partial view of a particular alternative embodiment of the main embodiment of the invention; and

FIG. 9 diagrammatically shows a partial view of a second embodiment of the invention.

### DETAILED DESCRIPTION OF THE INVENTION

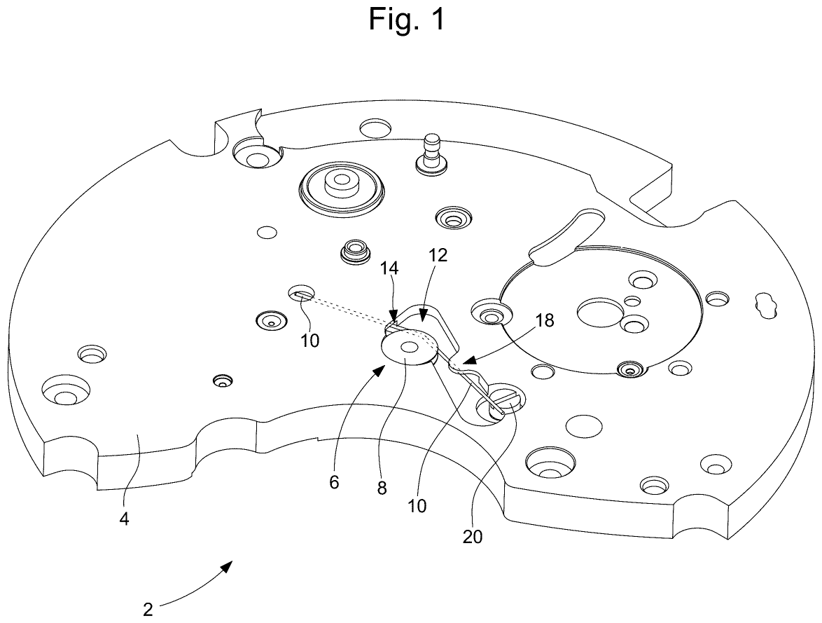

A main embodiment of a mechanical horological movement 2 according to the invention will be described below with reference to FIGS. 1 to 5.

The mechanical horological movement 2 comprises:
a barrel,
an escape wheel set 58 associated with a mechanical resonator (not shown in the figures),
a first wheel set 30, forming a display wheel set, intended to carry a display member, in particular a hand 48 of a chronograph function seconds display, and driven rotatably by a second wheel set 52 incorporated in a gear train from the barrel to the escape wheel set, the first wheel set not being included in this gear train,
a braking spring 10 arranged so as to be able to generate on the first wheel set 30, as soon as this first wheel set is subjected to a rotary drive torque, a braking torque intended to prevent the display member 48 from trembling, as well as a permanent radial force which keeps the display member in a stable position when it is stationary.

According to the invention, the mechanical horological movement 2 comprises a braking device 6 acting on the display wheel set and comprising the braking spring 10 and an intermediate part 8 arranged between the braking spring and an arbor 36 of the first wheel set 30. The braking spring is arranged so as to be able to generate, via the intermediate part against which this braking spring presses, a braking torque on the display wheel set, as soon as this display wheel set is subjected to a rotary drive torque. For this purpose, the intermediate part has a lateral surface 9 pressing against a surface of revolution 35 of the arbor, and a bearing surface 25 against which the braking spring exerts an overall pressing force in the direction of the arbor in order to generate a friction force between the lateral surface and the surface of revolution, this friction force generating the braking torque. Thus, the braking torque is exerted on the first wheel set/display wheel set by the braking spring via the intermediate part against which the braking spring presses. The intermediate part 8 and the braking spring 10 are arranged so that the intermediate part remains stationary and non-rotating in normal operation. The arbor 36 of the first wheel set and the intermediate part are configured so that the surface of revolution 35 of the arbor can slide on the lateral surface 9 while being subjected to a dynamic friction force which generates the braking torque. Before the surface of revolution slides on the lateral surface, a static friction force generates the braking torque and thus keeps the arbor stationary.

Preferably, the intermediate part 8 exerts an exclusively radial pressure on the arbor 36 of the first wheel set 30. According to an advantageous feature, the braking spring 10 exerts an exclusively radial overall pressing force on the intermediate part. The bearing surface 25 is opposite the lateral surface 9, i.e. the bearing surface is located on one side of the intermediate part 8 which is opposite another side of this intermediate part defining the lateral surface 9. This alternative embodiment is advantageous because the braking device bears against an undercut part whose radial shake varies little and thus gives a constant braking torque for a given friction force between the surface of revolution 35 and the lateral surface 9. In an advantageous alternative embodiment shown in the figures, the surface of revolution 35 of the arbor 36 is cylindrical and axial and the lateral surface 9 of the intermediate part is axial, i.e. the cylindrical surface of revolution 35 and the lateral surface 9 are oriented along the axis of rotation 42 of the first wheel set 30 which is coincident with the central axis of the arbor 36, the lateral surface 9 and the cylindrical surface of revolution 35 thus being parallel to this axis of rotation 42. In a preferred alternative embodiment, the intermediate part 8 and the braking spring 10 are configured so that said pressing force remains constant once the display wheel set is assembled in the movement and the braking device is fully assembled and adjusted.

According to a main alternative embodiment, the braking spring 10 is a wire spring or a strip spring whose longitudinal axis lies in a geometric plane parallel to a general plane 50 of the mechanical horological movement 2.

According to the alternative embodiment shown, the intermediate part 8 is a washer having a central cylindrical opening in which, without any interaction from the braking spring 10, the arbor 36 of the first wheel set 30 would slide and rotate freely, said lateral surface 9 of this washer 8 being defined by the cylindrical surface, which is preferably circular (i.e. of revolution), of its central cylindrical opening.

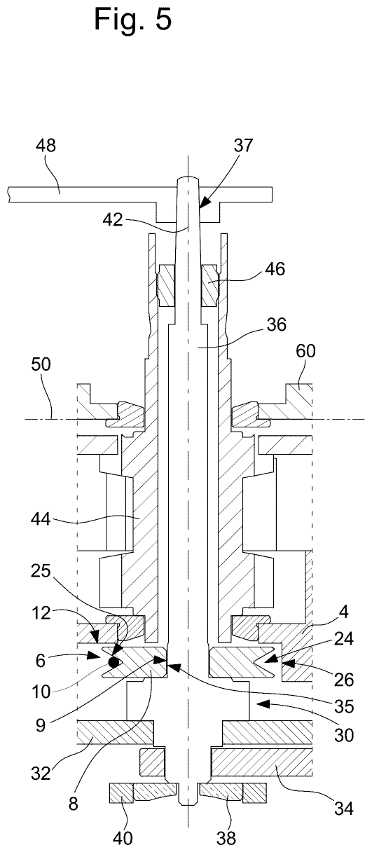

According to a particular alternative embodiment, the washer 8 has, on its periphery, a circular groove 24 defining the bearing surface 25 and into which is at least partially inserted part of the braking spring 10 which exerts the radial pressing force. In particular, the groove 24 has a V-shaped cross-section and the braking spring 10 is a wire spring with a circular cross-section, as shown in FIGS. 3 and 5. This arrangement allows the braking spring to be positioned axially in its middle part in contact with the washer. The spring is thus not free to move axially.

By way of non-limiting examples, in a first alternative embodiment, at least the part of the washer 8 defining its central cylindrical opening is made of a Copper Beryllium (CuBe) alloy when at least the part of the arbor defining the surface of revolution 35 is made of steel, or vice versa. This first alternative embodiment gives good tribological results. In a second alternative embodiment where said part of the arbor is made of steel or CuBe, at least the part of the washer defining its central cylindrical opening is made of polymers. Preferably, the entire washer is made of polymers. This second alternative embodiment is particularly advantageous for self-lubrication. In other alternative embodiments in which the arbor is made of steel or a copper alloy (for example CuBe or brass), at least the part of the washer defining its central cylindrical opening is made of bronze, nickel or gold, in particular in the form of a thin layer deposited on a base of another material in the case of nickel or gold, or more typically of a metal alloy containing gold or nickel. In other alternative embodiments, at least the part of the washer defining its central cylindrical opening is made of ceramic, in particular ruby or zirconia.

It should be noted that the material of the braking spring can be selected in such a way as to optimise the resilient nature of this spring and also its manufacture, without having to worry about friction and wear problems, given that the washer and more generally the intermediate part is intended to be static, i.e. stationary and non-rotating, during normal operation of the mechanical horological movement. In the case of the washer, in order to prevent it from rotating, changes can either be made to the shape of the intermediate part and/or to the shape of the braking spring, as will be explained in more detail below, or changes can be made, in particular in the case of a washer, to the materials used to make the spring and at least the outer part of the intermediate part in contact with the spring and/or to the surface treatment applied to these parts in order to obtain a high friction force between the braking spring and the intermediate part.

According to another preferred alternative embodiment, the braking spring 10 is arranged in the mechanical horological movement 2 in such a way that a middle part between its two end parts presses radially against the bearing surface 25 of the intermediate part/washer 8. More specifically, the braking spring 10 is arranged so that a middle part of this braking spring exerts said pressing force on the bearing surface 25 of the intermediate part/washer 8. To this end, the two end parts of the braking spring, located respectively on either side of said middle part, are stressed by two distant parts 16 and 20 of the horological movement so that this middle part exerts the pressing force on the bearing surface of the intermediate part/washer. This configuration of the braking device is advantageous because it allows the braking spring to be constantly pressed against the bearing surface of the intermediate part/washer. Moreover, this configuration is less sensitive to vibrations and impacts than if the braking spring had an anchoring point at one of its ends and a contact point at its other end.

In a particular alternative embodiment, the braking spring 10 is curved in its middle part and the bearing surface 25 of the intermediate part/washer 8 has a convex curvature in said geometric plane, relative to the arbor 36 of the first wheel set 30, and in particular a circular curvature in the case of the washer, which is followed, in a first alternative embodiment, by the middle part of the braking spring along the bearing surface. In a second alternative embodiment, the radius of curvature of the middle part is smaller than the average radius of curvature of the bearing surface, so that the braking spring presses against the intermediate part/washer at “two points” of the bearing surface, i.e. at two separate locations. It should be noted that, with a substantially V-shaped groove, a spring with a circular cross-section presses locally at a pair of axially aligned points. Thus, in such a configuration of the groove and of the braking spring, the latter presses at two pairs of points angularly spaced apart from one another, with each pair of points aligned in an axial direction, thus at “two points” projecting in the general plane of the spring, which is parallel to the general plane 50 of the movement. Finally, these alternative embodiments do not exclude other advantageous alternative embodiments in which the average radius of curvature of the middle part is greater than the radius of curvature of the bearing surface, resulting in the radial pressure being exerted at “one point” (i.e. at a pair of points aligned in an axial direction, but at a single point projecting in the general plane of the spring/general plane 50 of the movement).

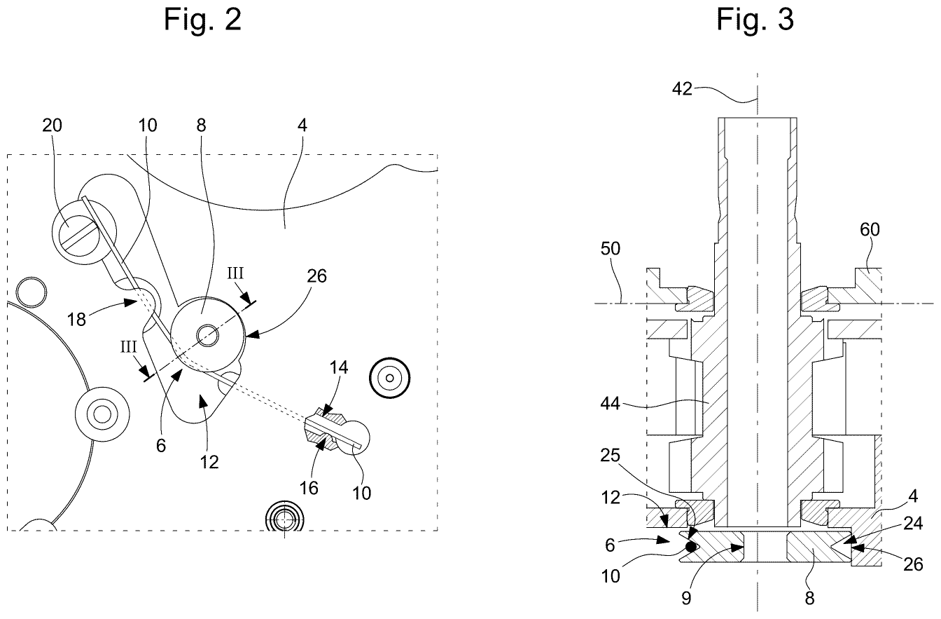

According to an advantageous alternative embodiment, as shown in FIG. 2, the braking spring 10 is not fastened to the movement by a specific part, but is held under tension by two parts 16 and 20 of this movement against which press two end portions of the braking spring located respectively on either side of a middle portion of this braking spring bearing radially against the intermediate part, which is in particular the washer 8. The direction of the force applied by the two parts 16 and 20 on the spring is the reverse of the direction of the reaction force of the intermediate part/washer 8 on the middle part of the spring. These forces, which are exerted on the braking spring in the geometric plane (horizontal plane orthogonal to the axis of rotation 42 of the arbor 36 coincident with its central axis) in which its longitudinal axis is located, generate a stress which holds the braking spring in place. Then, to prevent the spring from moving axially/vertically, and in particular its middle part from coming out of the groove 24, two parts of the support 4 are respectively provided on each of the two said sides, which parts define lower axial stops for the braking spring. On a first side, a groove 14 is provided in the support 4 (barrel bar) of the braking device, this support being able to support the washer 8 especially when assembling the washer before installing the spring. The bottom of this groove, forming a thin horizontal wall, provides a lower limit for any possible displacement of the part of the spring located on this side. On the second side, the braking spring is partially located above a small projecting part 18.

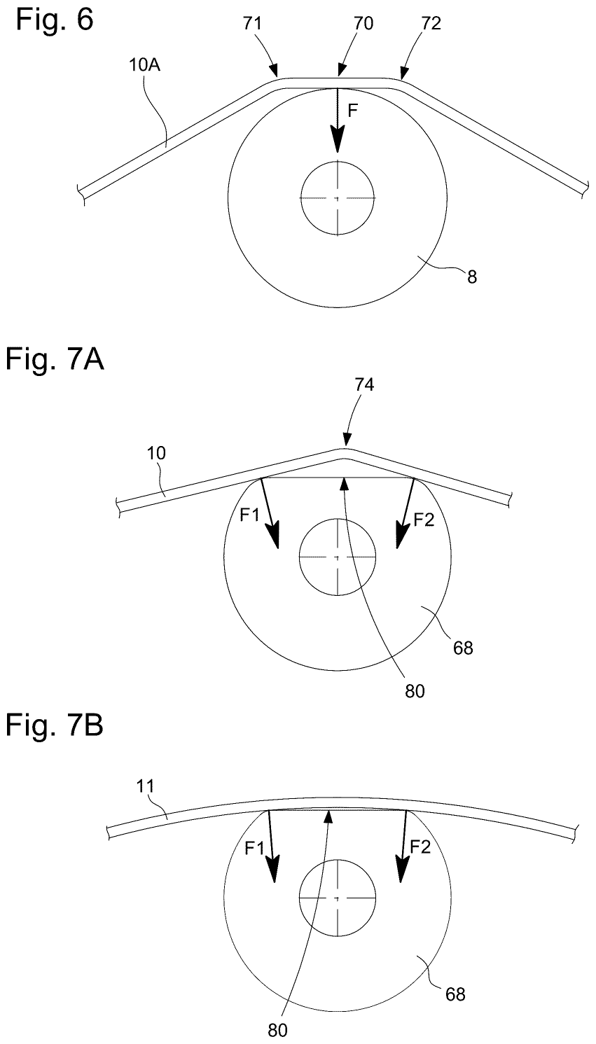

Various other advantageous alternative embodiments are shown diagrammatically in FIGS. 6, 7A and 7B. The alternative embodiment shown in FIG. 6 is characterised by a braking spring 10A with a middle part having two bends 71 and 72 which are separated by a straight section 70 (unstressed), which bears, substantially at its middle, against the circular washer 8. This ensures that the braking spring 10A bears at all times against the washer 8 at “one point”. The alternative embodiments of FIG. 7A to 7B are characterised by an intermediate part 68 which is not circular, but is formed by a truncated washer having a straight zone 80. In the alternative embodiment shown in FIG. 7A, the braking spring 10 has, in its middle part, a bend 74 which is located facing the straight zone 80 of the truncated washer 68. In the alternative embodiment shown in FIG. 7B, the spring 11 is straight/rectilinear without stress and, when it is tensioned to press against the intermediate part, it bends slightly (concave curvature when viewed from the intermediate part) so that it presses at the two ends of the straight zone 80 of this intermediate part. Thus, in the alternative embodiments of FIGS. 7A and 7B, the braking spring 10, or 11 respectively, exerts two forces F1 and F2 respectively at the two ends of the straight zone 80. The two forces F1 and F2 are radial as a whole, i.e. their sum at a mid-point is radial. However, each of the two forces exerts a moment of force on the intermediate part 68, so that if the spring moves longitudinally and one of the two forces F1 and F2 decreases relative to the other, the intermediate part 68 automatically undergoes a small rotation so as to re-establish a balance between the two opposing moments of force exerted thereon. The alternative embodiment shown in FIG. 7B is preferable because there is less risk of rotation of the truncated washer. Moreover, this alternative embodiment allows the desired braking torque to be maintained, even if the braking spring undergoes a certain longitudinal displacement in the event of an impact or sudden acceleration. However, the alternative embodiment shown in FIG. 7A, with a bent spring, is less likely to be subject to longitudinal displacement in the event of an impact. The alternative embodiment with a truncated washer is advantageous for preventing the intermediate part from rotating during normal operation, which is important for ensuring a constant braking torque as set. The alternative embodiments shown in FIGS. 7A and 7B provide support at all times at “two points” projecting in the geometric plane of the spring.

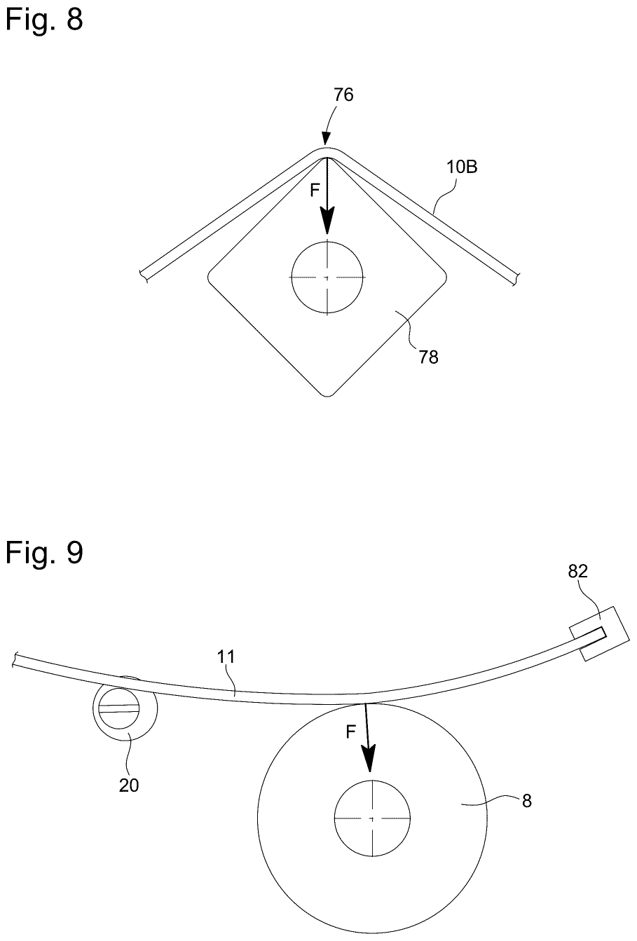

A particular alternative embodiment is diagrammatically shown in FIG. 8. This alternative embodiment, like that of FIG. 6, is designed to ensure that the braking spring 10B is pressed at all times at “one point” on the intermediate part 78, which has an overall square shape with rounded corners. The braking spring 10B has a bend 76 such that the two straight parts of this spring on either side of the bend are at an angle greater than 90° to one another, yet relatively close to this value, for example an angle equal to 110°. One of the rounded corners of the intermediate part is positioned in the bend 76 of the spring which, when this spring and the intermediate part 78 are stationary, exerts a substantially radial force F on the intermediate part. If the spring 10B moves, particularly as the result of an impact, the direction of the force varies so that the intermediate part is then subjected to a moment of force which causes it to rotate. This ensures that the same angle of the square intermediate part remains at all times in the bend 76 of the braking spring and that pressure is applied at “one point”. Furthermore, in normal operation (when the braking spring is stationary), this alternative embodiment keeps the intermediate part stationary (not rotating), thus ensuring a constant, well-defined braking torque on the arbor of the wheel set.

According to a preferred alternative embodiment of the invention, the braking device 6 comprises an eccentric 20 whose axis of rotation is perpendicular to the general plane 50, and thus parallel to the central axis/axis of rotation 42 of the wheel set 30, and which is arranged so as to press radially against the braking spring in order to be able to vary, by rotation about its axis of rotation, said radial pressing force exerted by the braking spring on the intermediate part/washer. In the advantageous alternative embodiment shown in FIGS. 1 and 2, the eccentric 20 constitutes one of the two parts that keep the braking spring under tension. Thus, by turning the eccentric 20, the stress on this spring is varied, making it possible to adjust a braking torque applied to the first wheel set 30 (chronograph wheel set) when it is subjected to a rotary drive torque. This configuration is advantageous because it is not sensitive to vibrations and impacts. In another alternative embodiment, another device for adjusting the radial force is provided, in particular a device fitted with a pressing member capable of being moved linearly.

FIG. 9 shows another embodiment of the invention in which the braking spring 11 is straight/rectilinear (without stress). This spring is rigidly fastened at one of its two ends in a fixed part 82, the angular position of which in the geometric plane cannot be modified, thus preventing any involuntary displacement or displacement due to an impact. The groove in the part 82 into which the end of the spring 11 is inserted is oriented so that a middle zone of the spring exerts a radial pressing force F on the washer 8, this spring then having a first convex curvature (when viewed from the washer) between the fastening part 82 and the bearing point of the spring on the washer. Preferably, at the other end of the spring, to adjust the radial force F, an eccentric is provided which, in this embodiment, is located on the same side of the braking spring as the washer 8 which forms the intermediate part between the braking spring and the arbor of the wheel set concerned. Thus, the braking spring 11 also has a second convex curvature between said bearing point and the eccentric 20, this second curvature being less than the first curvature because the radial force F is not zero. It should be noted that the alternative embodiment shown in FIG. 9 defines a construction of the type having a single bearing point, i.e. with the braking spring bearing on the washer at “one point”, according to the definition given above. In another alternative embodiment of the “two points” type, a star-shaped intermediate part is provided, for example with four to six tips each having a small, rounded portion. The slightly convex braking spring bears at all times on two tips of the star-shaped intermediate part, thus exerting two forces which form, at their central point, a radial overall pressing force. In other words, the two forces generate two opposing moments of force on the intermediate part that are of equal intensity. It should also be noted that in the event of an impact, the braking device cannot be deregulated.

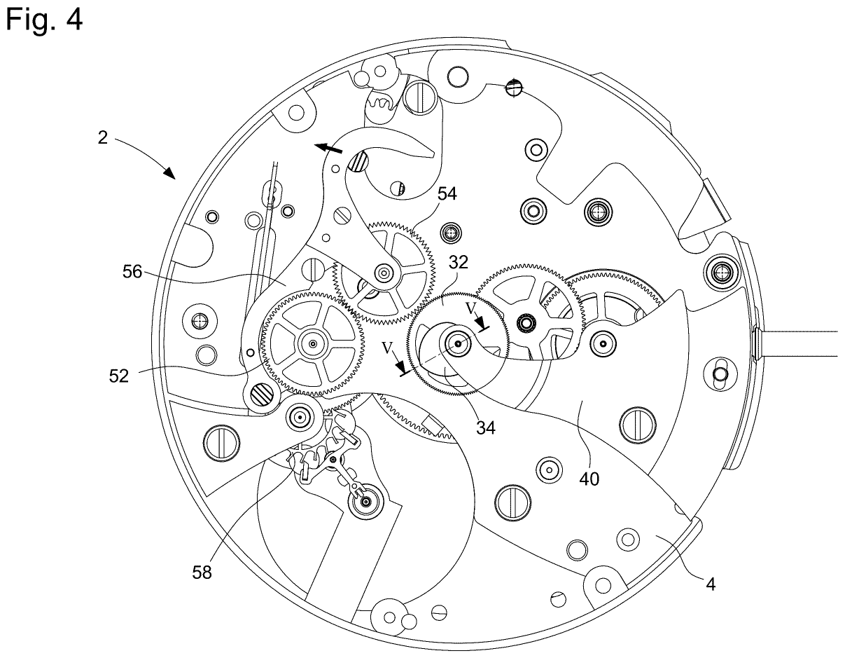

FIGS. 1 to 3 show the mechanical horological movement 2 with the braking device 6 preassembled in a preliminary step prior to the assembly of the first wheel set 30. This preliminary assembly of the braking device 6 is advantageous. It is made possible in particular by the fact that the force exerted by the braking spring is radial and by the fact that the washer 8 is provided above a pinion and a wheel 32 forming the first wheel set and, in the example shown where the first wheel set is a chronograph wheel set, a reset heart piece 34. FIGS. 4 and 5 show the mechanical horological movement 2 after the first wheel set 30 has been mounted in this movement and the braking device in an operational state.

To allow preliminary assembly of the braking device 6, the washer 8 is arranged on a support 4 (barrel bar) which has, on the periphery of this washer, an abutment surface 26 located horizontally facing the washer and diametrically opposite said bearing surface 25, so that the washer 8 and the braking spring 10 can be preassembled in the mechanical horological movement 2, before assembly of the first wheel set 30, with the washer bearing against the abutment surface 26, as shown in FIGS. 1 to 3. The abutment surface 26 is defined by a lateral surface of a cavity 12 machined in the support 4, the washer being arranged in this cavity 12 which is open on the lower side of the movement (by definition, the analogue display is on the upper side).

In a preferred alternative embodiment, the abutment surface 26 is arranged so that, following prior assembly of the washer 8 and the braking spring 10, the central cylindrical opening in the washer has at least one zone that is superimposed with the central circular opening in a pipe or tube 44, into which part of the arbor 36 of the first wheel set 30 (chrono wheel set) is then inserted, so that when the first wheel set is mounted in the mechanical horological movement 2, the arbor can penetrate the two central circular openings without initially having to exert a radial force on the washer. As can be seen in FIG. 3, in the alternative embodiment shown, the central cylindrical opening in the washer 8 is entirely superimposed on the central circular opening in the pipe 44. It should be noted that, in the example shown, the arbor 36 of the first wheel set 30 is inserted into a pipe 44 which carries a display hand and is thus rotatable, this pipe being pivoted in the plate 60 and the barrel bar 4. An internal bearing 46 is arranged inside the central opening in the pipe, in which internal bearing pivots an end part 37 of the arbor 36 on which the chrono hand 48 is mounted, this end part having a maximum diameter smaller than the diameter of the surface of revolution 35, which is in particular cylindrical and axial, and which is ultimately located inside the central cylindrical opening 9 in the washer. In particular, this facilitates the insertion of the arbor 36 into the two central circular openings when the chrono wheel set is assembled, when the initial superposition of the two central circular openings, prior to the assembly of this chrono wheel set, is only partial.

Once mounted, the first wheel set 30, which in the illustrated embodiment forms a chronograph wheel set, is pivoted by the upper bearing 46 and by a lower bearing 38 arranged in an opening in a bar 40, and the washer 8 no longer bears against the side wall 26 of the cavity 12 of the support 4, but bears, via its central cylindrical opening, against the arbor 36 of the first wheel set, more precisely against a surface of revolution 35, which is advantageously cylindrical and axial, of this arbor. It should be noted that in the alternative embodiment shown, the barrel is pivoted between the barrel bar 4, forming the support part for the washer 8, and the plate 60. The first wheel set is driven rotatably at times, on command, by a second wheel set 52 via a clutch wheel 54 mounted on a lever 56, which is controlled conventionally by a column wheel or a cam (disengagement shown by an arrow in FIG. 4). The second wheel set 52 comprises a drive wheel which is incorporated into the gear train from the barrel to the escape wheel 58. This drive wheel forms here a small seconds wheel of the time display of the watch receiving the mechanical horological movement 2.

The present invention has been described in detail for a chronograph wheel set 30, but the braking device of the invention can be provided for other wheel sets of a mechanical horological movement, in particular for a small seconds wheel set when this wheel set is not included in the gear train from the barrel to the escape wheel 58.

The invention has several advantages, some of which have already been described. The braking device 6 comprises an eccentric 20 which makes it easy to adjust the radial pressing force exerted by the braking spring on the intermediate part/washer 8 and via this the radial force applied to the arbor 36 of the first wheel set 30, and to adjust the moment of frictional force applied to this first wheel set. The eccentric 20 allows the braking torque to be adjusted once the braking device has been fully mounted in the mechanical horological movement and without having to remove the braking spring in order to slightly modify its initial shape. Given the presence of the washer 8 between the braking spring 10 and the arbor 36, and in addition to the fact that the forces involved are intended to be radial, the fitting of the chrono hand 48 on the first wheel set 30 and especially its removal, for example when this hand 48 is changed or when cleaning the mechanical horological movement, cannot damage the braking spring which is the delicate element in the braking device 6, the washer 8 being much more robust and able to withstand a certain amount of axial pressure against the support 4.

The braking device 6 is such that it is protected against stresses that could damage it during the assembly of other parts of the mechanical horological movement, in particular during the assembly of the chrono wheel set 30. When the horological movement is removed, and in particular when the first wheel set 30 is removed, the braking device 6 can remain in place without altering its settings.

The braking device according to the invention makes it possible to predetermine the moment of frictional force relatively precisely, since the lateral surface 9 of the intermediate part, in particular of the washer 8, has a height which is generally much greater than that of the braking spring, since the material of the intermediate part/washer 8 can be selected and since the diameter of the surface of revolution, defining a cylindrical and axial surface, of the arbor 36 against which the intermediate part/washer 8 bears is precisely determined.

1-17. (canceled)

18. A mechanical horological movement comprising:
a barrel;
an escape wheel set associated with a mechanical resonator;
a display wheel set comprising an arbor configured to carry a display member;
a braking device associated with the display wheel set and comprising a braking spring; and
an intermediate part arranged between the braking spring and the arbor of the display wheel set, the display wheel set being configured to be driven rotatably by the barrel but not forming part of a gear train from the barrel to the escape wheel set, and the braking spring being configured to generate, via the intermediate part against which the braking spring presses, a braking torque on the display wheel set, as soon as the display wheel set is subjected to a rotary drive torque, wherein
the intermediate part and the braking spring are arranged so that the intermediate part remains stationary and non-rotating in a normal operation, and
the intermediate part has a lateral surface pressing against a surface of revolution of the arbor, and a bearing surface against which the braking spring exerts an overall pressing force towards the arbor in order to generate a friction force between the lateral surface and the surface of revolution that generates the braking torque.

19. The mechanical horological movement according to claim 18, wherein the intermediate part exerts exclusively radial pressure on the arbor of the display wheel set.

20. The mechanical horological movement according to claim 19, wherein
the arbor defines a central axis,
the surface of revolution is cylindrical and axial, and
the lateral surface is axial.

21. The mechanical horological movement according to claim 19, wherein the braking spring is a wire spring or a strip spring whose longitudinal axis is located in a geometric plane parallel to a general plane of the movement.

22. The mechanical horological movement according to claim 21, wherein
the braking spring is arranged so that a middle part of the braking spring exerts the pressing force on the bearing surface of the intermediate part, and
two end parts of the braking spring, located respectively on either side of the middle part, are stressed by two distant parts of the horological movement so that the middle part exerts the pressing force on the bearing surface.

23. The mechanical horological movement according to claim 22, wherein the braking spring is not fastened to the horological movement but is held under tension by the distant parts of the horological movement against which the two end parts of the braking spring press in two directions in the geometric plane.

24. The mechanical horological movement according to claim 23, wherein the intermediate part and the braking spring are configured in such a way that a relative positioning substantially does not vary over time, even in an event of a longitudinal displacement of the braking spring as a result of an acceleration to which the movement is subjected in the general plane.

25. The mechanical horological movement according to claim 22, further comprising an eccentric whose axis of rotation is perpendicular to the geometric plane and which is pressing against the braking spring in order to be able to vary, by rotation about the axis of rotation, the pressing force exerted by the braking spring on the intermediate part.

26. The mechanical horological movement according to claim 25, wherein the intermediate part is a washer having a central opening through which the arbor of the display wheel set passes, the lateral surface of the washer being defined by a cylindrical surface of the central opening.

27. The mechanical horological movement according to claim 26, wherein the washer has, on a periphery, a groove defining the bearing surface and into which is inserted at least partially a part of the braking spring exerting the pressing force in a direction of the arbor.

28. The mechanical horological movement according to claim 18, wherein the intermediate part is a washer having a central opening through which the arbor of the display wheel set passes, the lateral surface of the washer being defined by a cylindrical surface of the central opening.

29. The mechanical horological movement according to claim 28, wherein the washer has, on a periphery, a groove defining the bearing surface and into which is inserted at least partially a part of the braking spring exerting the pressing force in a direction of the arbor.

30. The mechanical horological movement according to claim 18, wherein the intermediate part is arranged on a support which has at a periphery of the intermediate part an abutment surface situated horizontally facing the intermediate part and diametrically opposite the bearing surface, so that the intermediate part and the braking spring can be preassembled in the mechanical horological movement, before assembling the display wheel set, with the intermediate part bearing against the abutment surface.

31. The mechanical horological movement according to claim 30, wherein the abutment surface is arranged in such a way that, following a prior assembly of the intermediate part and of the braking spring, a central cylindrical opening in the intermediate part has at least one zone that is superimposed with the central cylindrical opening in a pipe or tube, which is rotatable or fixed, into which part of the arbor of the display wheel set is inserted, so that the arbor can, when the display wheel set is mounted in the mechanical horological movement, penetrate two central circular openings without initially having to exert a radial force on the intermediate part.

32. The mechanical horological movement according to claim 18, wherein
at least part of the arbor defining the surface of revolution is made of steel or consists of a copper alloy, and
at least part of the intermediate part defining the lateral surface consists of a copper alloy or steel respectively.

33. The mechanical horological movement according to claim 18, wherein
at least part of the arbor defining the surface of revolution is made of steel or consists of a copper alloy, and
at least part of the intermediate part defining the lateral surface consists of polymers.

34. The mechanical horological movement according to claim 18, wherein at least part of the arbor defining the surface of revolution is made of steel or consists of a copper alloy and at least part of the intermediate part defining the lateral surface consists of a ceramic or of a material containing gold or nickel and forming an outer layer at least partially covering the intermediate part.

35. The mechanical horological movement according to claim 34, wherein the ceramic comprises one of ruby and zirconia.
